(19) United States
(12) Patent Application Publication
(10) Pub. No.: US 2015/0367897 A1
(43) Pub. Date: Dec. 24, 2015

(54) ADJUSTABLE CAB SYSTEM FOR MACHINE

(71) Applicant: CATERPILLAR PAVING PRODUCTS INC., Brooklyn Park, MN (US)

(72) Inventors: Daniel S. Gillard, Hastings, MN (US); Mario J. Souraty, Plymouth, MN (US); Jason W. Muir, Andover, MN (US); Dario Sansone, Castello d'Argile (IT)

(73) Assignee: CATERPILLAR PAVING PRODUCTS INC., Brooklyn Park, MN (US)

(21) Appl. No.: 14/838,370

(22) Filed: Aug. 28, 2015

(51) Int. Cl. B62D 33/063; B60R 21/13

(52) U.S. Cl. CPC B62D 33/063; B60R 21/13

(57) ABSTRACT

A cab system with a cab, a roll over protection structure (ROPS), and a pair of actuators, is provided. The cab includes a ceiling portion, a base portion, and at least one collapsible column. The at least one collapsible column includes an upper arm connected to the ceiling portion and a lower arm connected to the base portion. The actuating cylinder actuates to maintain the cab between a first pre-determined height and a second pre-determined height, via slidable actuation of the upper arm. The ROPS includes a canopy to cover the cab, which is secured between a pair of telescopic support members. The telescopic support member includes a movable column with a canopy end attached to the canopy and a fixed column with a frame end connected to the frame. The actuator moves the movable column to adjust the canopy between a first pre-determined distance and a second pre-determined distance.

### TECHNICAL FIELD

The present disclosure relates to an adjustable cab system for machines. More particularly, the present disclosure relates to adjustable cab systems that can alter a height of the machine.

### BACKGROUND

Machines, such as rotary mixers, typically include a cab mounted on a frame. Such machines generally include a roll over protection structure (ROPS) to protect the cab during a rollover event. Typically, the ROPS may include two pillars that support a canopy. The canopy partially or wholly overlays a top portion of the cab and generally forms the highest component to define the machine's overall height.

For shipping and transportation purposes, a tall profiled machine or a heightened canopy portion generally adds to the difficulty of effective packaging and shipping. This is because, heightened and extended portions of the machine may interfere and damage itself and the surrounding structures. As a result, transportation may be unsafe if a complex machinery is improperly stored. Moreover, transportation costs are commensurate with a bulk and size of the machine. Therefore, portions of the machine that remain outwardly projected, such as the ROPS structure, remain as one of a constriction to an effective transportation solution.

Japanese Patent Number 4,149,247 discloses a ROPS associated with a machine with an upper body, which freely moves up and down, to facilitate a height adjustment of the ROPS. However, the upper body tilts along the length of the machine to alter the height of the ROPS, which may considerably weaken the strength and stability of the ROPS. The present disclosure seeks to address one or more of the problems associated with known.

### SUMMARY OF THE INVENTION

Various aspects of the present disclosure describe a cab system for a machine. The machine includes a frame. The cab system includes a cab, a roll over protection structure (ROPS), and a pair of actuators. The cab includes a ceiling portion, a base portion, and a number of collapsible columns. The base portion is fixedly connected to the frame. The collapsible column includes an upper arm connected to the ceiling portion and a lower arm connected to the base portion. The upper arm and the lower arm are slidably connected to each other. The actuating cylinder facilitates slidable actuation between the ceiling portion and the base portion. The actuating cylinder is operable to adjust a distance between the ceiling portion and the base portion. The distance is adjusted between a first pre-determined height and a second pre-determined height. The ROPS includes a canopy and a pair of telescopic support members. The pair of telescopic support members is laterally spaced apart and is substantially parallel to the upright extension of the base portion. The canopy is secured between the pair of telescopic support members to at least substantially cover an operator. The telescopic support member includes a fixed column and a movable column. The movable column includes a canopy end attached to the canopy. The fixed column includes a frame end connected with the frame. The actuator is configured to move the movable column relative to the fixed column. This is done to adjust the canopy between a first pre-determined distance and a second pre-determined distance, along the upright extension, relative to the frame.

### BRIEF DESCRIPTION OF THE DRAWINGS

FIG. 1 is a side view of a machine with a cab system, in accordance with the concepts of the present disclosure;

FIG. 2 is a partial perspective view of the machine of FIG. 1, with a cab and a roll over protection structure (ROPS), in accordance with the concepts of the present disclosure;

FIG. 3 is a perspective view of an isolated assembly of the cab and the ROPS of FIG. 2, illustrating the cab system at an operational position, in accordance with the concepts of the present disclosure; and

FIG. 4 is a perspective view of the isolated assembly of the cab and the ROPS of FIG. 2, illustrating the cab system at a collapsed position, in accordance with the concepts of the present disclosure.

### DETAILED DESCRIPTION

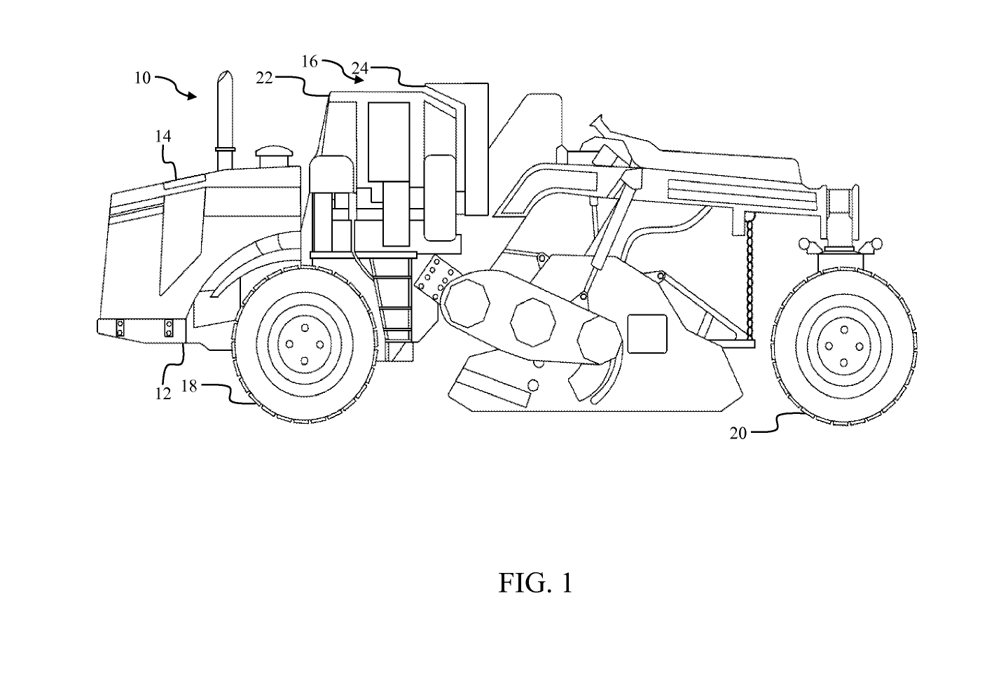

Referring to FIG. 1, an exemplary machine 10 is illustrated. The machine 10 includes a frame 12, an engine compartment 14, and an adjustable cab system 16. The engine compartment 14 is mounted on the frame 12. The engine compartment 14 houses an engine (not shown) and powers a hydrostatic propel system for the front wheels 18 and rear wheels 20 of the machine 10. The frame 12 extends from front wheels 18 to the rear wheels 20, and supports the adjustable cab system 16. The adjustable cab system 16 is hereafter referred to as the cab system 16, for simplicity. Although the depicted embodiment shows a rotary mixer as the machine 10, it is contemplated that the disclosed cab system 16 may have applications in other work machines, such as excavator, pavers, and the like. The cab system 16 houses many controls necessary to operate the machine 10.

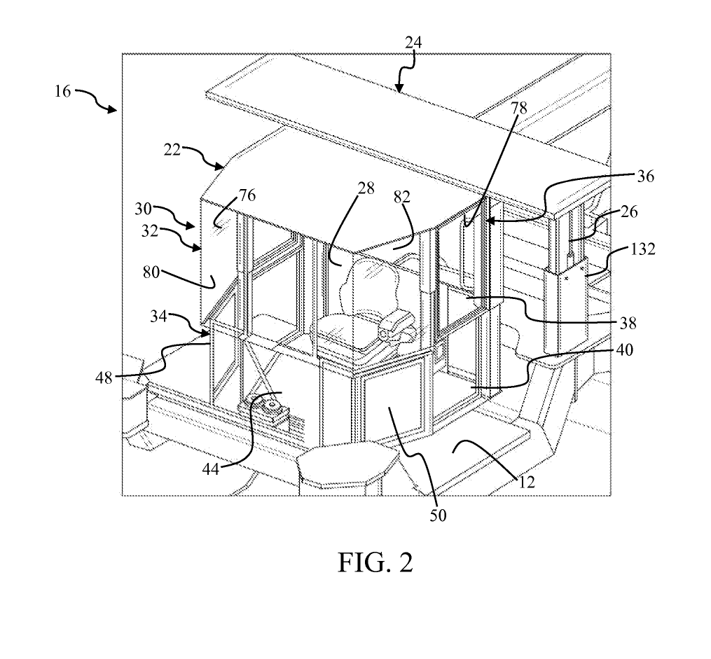

Referring to FIG. 2, there is shown a partial view of the machine 10 with the cab system 16. The cab system 16 includes a cab 22, a ROPS 24, and one or more actuators 26. The cab 22 includes a hexagonal profile. However, it may be contemplated that the cab 22 may include pentagonal or other polygonal profiles. The cab 22 includes an operator drive seat 28 and a body 30.

The body 30 generally defines an enclosure within which there is the operator drive seat 28. The operator drive seat 28 is proximal to an operator station from where an operator may control one or more functions of the machine 10. The body 30 includes an upper body portion 32, a lower body portion 34, and a door 36. The upper body portion 32 is slidably movable along a vertical axis relative to the lower body portion 34, such that the upper body portion 32 acts as an outer shell relative to the lower body portion 34. Structure of the upper body portion 32 complements and is adjustable relative to the lower body portion 34 in a telescopic fashion.

The door 36 includes an upper portion 38 and a lower portion 40. The upper portion 38 is a part of the upper body portion 32, and is slidable relative to the lower portion 40. The upper portion 38 may also be formed substantially of a transparent material, such as glass or plastic.

The lower body portion 34 includes a base portion 42, a front panel 44, a back panel 46, a first side panel 48, a second side panel 50, a lateral panel 52, and the lower portion 40 of the door 36. The front panel 44 is attached to the first side panel 48 on one side and to the second side panel 50 on other side.

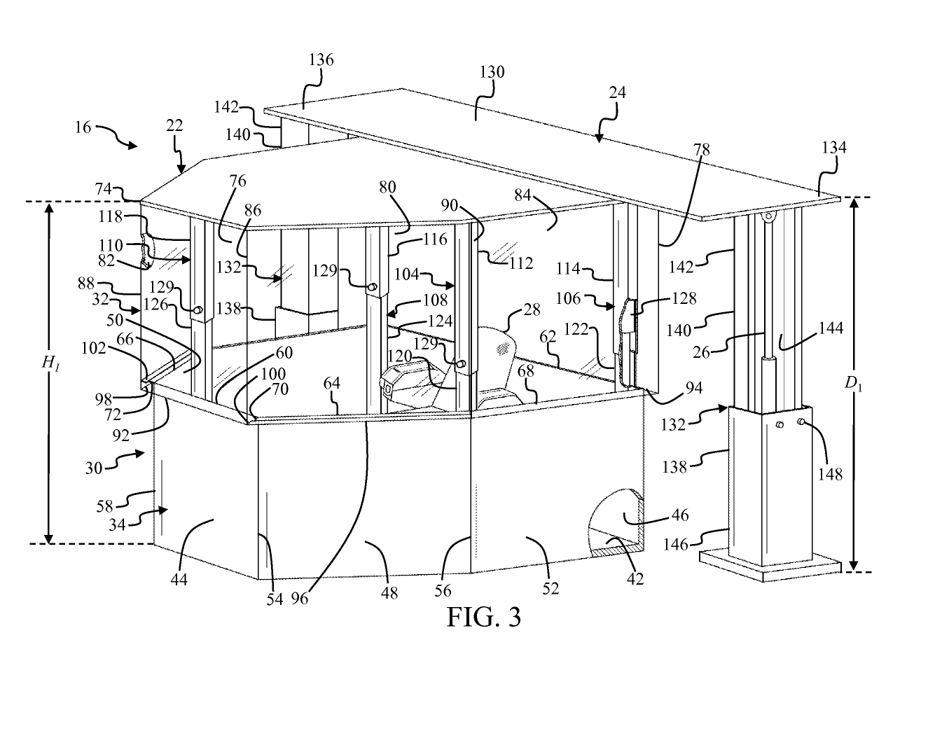

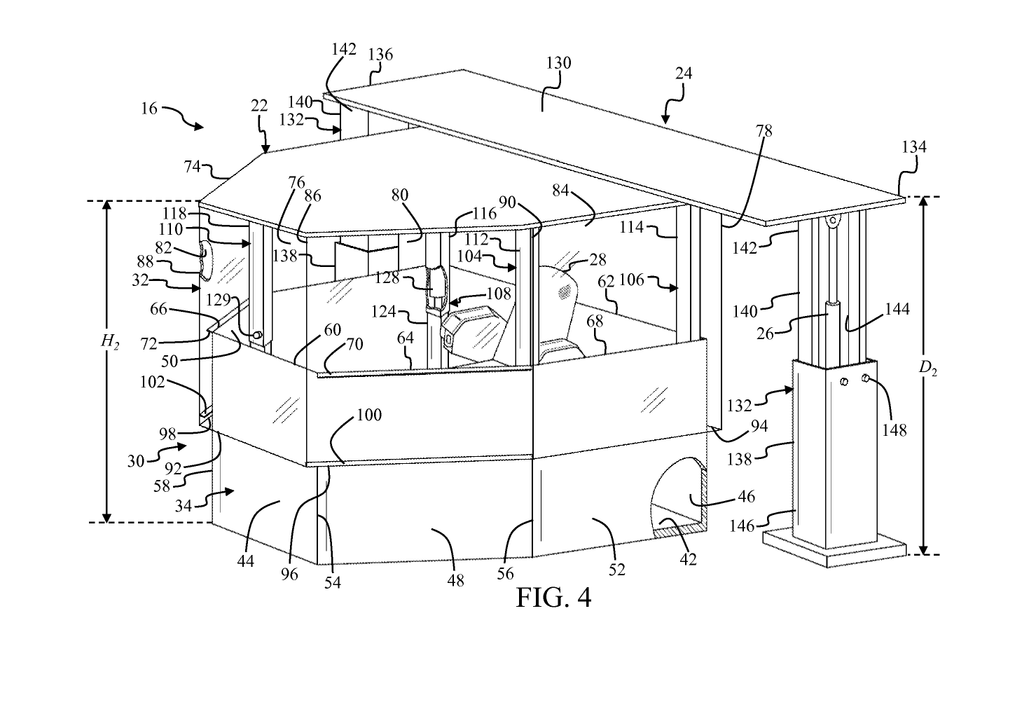

Referring to FIG. 3 and FIG. 4, the first side panel 48 is connected to the front panel 44 along a first edge 54. The first side panel 48 is connected to lateral panel 52 along a second edge 56. The lateral panel 52, in turn, is attached to the back panel 46. The second side panel 50 is attached to the front panel 44 along a third edge 58. As shown in FIG. 1, the lower portion 40 of the door 36 is positioned between the back panel 46 and the second side panel 50.

In addition, each of the front panel 44, the first side panel 48, the second side panel 50, the lateral panel 52, and the back panel 46 are attached to the base portion 42 (shown in FIGS. 1 and 2). The front panel 44, the back panel 46, the first side panel 48, the second side panel 50, and the lateral panel 52, include free ends 60, 62, 64, 66, and 68, respectively. The free ends 60, 62, 64, 66, and 68 are upright relative to the base portion 42.

The free ends 64 and 66 of the first side panel 48 and the second side panel 50, include outer flanges 70 and 72, respectively. The outer flanges 70 and 72 extend outwards from the first side panel 48 and the second side panel 50, respectively. In an embodiment, edges of the outer flanges 70 and 72 are covered with compression seals (not shown). The compression seals (not shown) aid to prevent water, dust, noise, and vibrations from entering the cab 22.

The upper body portion 32 includes a ceiling portion 74, a front window 76, a back window 78, a first side window 80, a second side window 82, and a lateral window 84. The front window 76 is attached to the first side window 80 on one side and the first side window 80 on other side.

The first side window 80 and the second side window 82 are angled from the front window 76 towards the back window 78. The first side window 80 is connected to front window 76 along a fourth edge 86. The second side window 82 is connected to front window 76 along a fifth edge 88. In addition, the first side window 80 is attached to the lateral window 84 along a sixth edge 90.

The lateral window 84 is nearly perpendicular to the back window 78. The lateral window 84 is attached to the back window 78. As shown in FIG. 1, the upper portion 38 of the door 36 is defined between the back window 78 and the second side window 82. The windows 76, 78, 80, 82, and 84 may be empty openings or fitted with a transparent material such as glass or plastic to allow viewability across the windows 76, 78, 80, 82, and 84, and outside the cab system 16.

Each of the front window 76, the back window 78, the first side window 80, and the second side window 82 are connected to the ceiling portion 74 of the cab 22. This results in the formation of an enclosed outer shell defined by a concerted assembly of the front window 76, the back window 78, the first side window 80, and the second side window 82, with the ceiling portion 74. The front window 76, the back window 78, the first side window 80, and the second side window 82 include free ends 92, 94, 96, and 98. The free ends 96 and 98 of the first side window 80 and the second side window 82 include inner flanges 100 and 102, respectively. The inner flanges 100 and 102 extend inwards from the first side panel 48 and the second side panel 50, respectively. In an embodiment, edges of the inner flanges 100 and 102 are covered with compression seals (not shown). It is desired to maintain the inner flanges 100 and 102 in contact with the outer flanges 70 and 72, in all positions, to prevent water, dust, noise, and vibrations from entering the cab 22.

The cab 22 also includes a first collapsible column 104 (or simply first column 104), a second collapsible column 106 (or simply second column 106), a third collapsible column 108 (or simply third column 108), and a fourth collapsible column 110 (or simply fourth column 110). The first column 104, the second column 106, the third column 108, and the fourth column 110 are disposed between the ceiling portion 74 and the base portion 42. The first column 104 is positioned proximal to the second edge 56. The second column 106 and the third column 108 are positioned proximal to the back panel 46. The fourth column 110 is positioned proximal to the second side panel 50. However, in other embodiments the number and position of the columns 104, 106, 108, and 110 may vary depending on design and strength of the cab 22.

The first column 104, the second column 106, the third column 108, and the fourth column 110 include upper arms 112, 114, 116, 118 and lower arms 120, 122, 124, 126. The upper arms 112, 114, 116, and 118 are attached to the ceiling portion 74. The lower arms 120, 122, 124, and 126 are attached to the base portion 42. The upper arms 112, 114, 116, and 118 include dimensions larger than the dimensions of the lower arms 120, 122, 124, and 126. This allows the upper arms 112, 114, 116, and 118 to slide over the lower arms 120, 122, 124, and 126. The first column 104, the second column 106, the third column 108, and the fourth column 110 house actuating cylinders 128. The actuating cylinders 128 retract to move the upper arms 112, 114, 116, and 118 towards the base portion 42, relative to the lower arms 120, 122, 124, and 126. The actuating cylinders 128 expand to move the upper arms 112, 114, 116, and 118 upwards, opposite to the base portion 42, relative to the lower arms 120, 122, 124, and 126. This movement facilitates a slidable actuation between the ceiling portion 74 and the base portion 42. The actuating cylinders 128 are operable to adjust a distance between the ceiling portion 74 and the base portion 42 between a first pre-determined height, H₁ and a second pre-determined height, H₂. The first pre-determined height, H₁ and the second pre-determined height, H₂, are attained by slidable movement of the upper body portion 32 with respect to the lower body portion 34. In an embodiment, the movement of the upper body portion 32 with respect to the lower body portion 34, to alter height of the cab 22 between the first pre-determined height, H₁ and the second pre-determined height, H₂, may also be actuated by other mechanisms, such as gear and motor system, a sliding rail system, bar linkage lift systems, and/or the like.

Each of the first column 104, the second column 106, the third column 108, and the fourth column 110 includes a number of load bearing pins 129. The load bearing pins 129 pass through the upper arms 112, 114, 116, 118 and then through the lower arms 120, 122, 124, 126, respectively. This locks the upper arms 112, 114, 116, 118 relative to the lower arms 120, 122, 124, 126 for one of the first pre-determined height, H₁ and the second pre-determined height, H₂. Hence, this prevents undesirable motion between the upper arms 112, 114, 116, 118 and the lower arms 120, 122, 124, 126, respectively.

In addition, the cab system 16 includes the ROPS 24, which is positioned proximal to the back panel 46 and the back window 78 of the cab 22. The ROPS 24 is supported by the frame 12. The ROPS 24 is provided for protection of the cab 22. The ROPS 24 includes a canopy 130 and a pair of telescopic support members 132.

The canopy 130 is secured between the pair of telescopic support members 132, to substantially cover the cab 22. The canopy 130 covers the cab 22 in such a way that a gap is maintained between the ceiling portion 74 of the cab 22 and the canopy 130, with the canopy 130 being relatively higher than the ceiling portion 74. The canopy 130 includes a first end 134 and a second end 136. The first end 134 and the second end 136 are attached to the pair of telescopic support members 132.

The telescopic support members 132 are supported by the frame 12 and act as attachment means of the ROPS 24 to the frame 12. The telescopic support members 132 are laterally spaced apart. The telescopic support members 132 are parallel to the upright extension of the base portion 42. The pair of telescopic support members 132 includes a fixed column 138 and a movable column 140. The movable column 140 includes a canopy end 142, which is attached to the first end 134 of the canopy 130. The movable column 140 is slidably movable relative to the fixed column 138. In addition, the movable column 140 includes a cavity portion 144 along a length. The cavity portion 144 houses the actuator 26. The actuator 26 is provided to move the movable column 140 relative to the fixed column 138. This is done to adjust the canopy 130 between a first pre-determined distance, D₁ (FIG. 3) and a second pre-determined distance, D₂ (FIG. 4), along the upright extension, relative to the frame 12. In an embodiment, the telescopic support members 132 may not be fixed, but may be capable to swing towards and away from the cab 22. In this embodiment, the actuator 26 may be placed external to the telescopic support members 132. The actuator 26 is obliquely aligned relative to the telescopic support members 132, with a top end of the actuator 26 is attached to the canopy 130 and a bottom end is attached to a portion of the frame 12, behind the cab 22. Contraction of the actuator 26 swings half the telescopic support members 132, and results in fold over of the canopy 130 in a backward direction, away from the cab 22.

The fixed column 138 has a hollow structure and accommodates the movable column 140. The fixed column 138 includes a frame end 146, which is connected with the frame 12. Dimensions of the movable column 140 are such that a portion of the movable column 140 can slide inside the fixed column 138.

The telescopic support members 132 include a number of load bearing pins 148. The load bearing pins 148 pass through the fixed column 138 and then through the movable column 140. The load bearing pins 148 lock the fixed column 138 relative to the movable column 140 for the first pre-determined distance, D₁ and a second pre-determined distance, D₂. Hence, this prevents undesirable motion between the fixed column 138 and the movable column 140.

FIG. 3 shows the cab system 16 with the cab 22 maintained at the first pre-determined height, H₁ and the ROPS 24 maintained at the first pre-determined distance, D₁. The first pre-determined height, H₁ is greater than the second pre-determined height, H₂. Similarly, the first pre-determined distance, D₁ is greater than the second pre-determined distance, D₂. The first pre-determined height, H₁ and the first pre-determined distance, D₁ may be referred to as an operational position of the cab system 16. For the operational position, the first pre-determined distance, D₁ corresponds to the first pre-determined height, H₁, such that the gap is maintained between the canopy 130 of the ROPS 24 and the ceiling portion 74 of the cab 22. In the operational position, the outer flanges 70 and 72 come in proximity with the inner flanges 100 and 102, respectively. This mitigates entry of dust and other unwanted particles into the cab 22.

FIG. 4 shows the cab system 16 is with the cab 22, maintained at the second pre-determined height, H₂. The ROPS 24 is maintained at the second pre-determined distance, D₂. The second pre-determined height, H₂ and the second pre-determined distance, D₂ may be referred to as a collapsed position. For the collapsed position, the second pre-determined distance, D₂ corresponds to the second pre-determined height, H₂, such that the gap is maintained between the canopy 130 of the ROPS 24 and the ceiling portion 74 of the cab 22. In the collapsed position, the outer flanges 70 and 72 move vertically away from the inner flanges 100 and 102, respectively. The movement is in such a way that entry of dust and other unwanted particles into the cab 22 are checked.

### INDUSTRIAL APPLICABILITY

In operation, the cab system 16 of the machine 10 is maintained in the functional position, with the cab 22 being maintained at the first pre-determined height, H₁ and the ROPS 24 being maintained at the first pre-determined distance, D₁. The cab 22 is maintained at the first pre-determined height, H₁, by expanded position of the actuating cylinders 128 in the columns 104, 106, 108, and 110. The ROPS 24 is maintained in the first pre-determined distance, D₁, by the expanded position of the actuators 26 of the pair of telescopic support members 132. To ship and store the apparatus, it may be favorable to maintain the cab system 16 in the collapsed position. The cab system 16 is maintained in the collapsed position by restriction of the cab 22 at the second pre-determined height, H₂ and the ROPS 24 at the second pre-determined distance, D₂. The cab 22 is collapsed to the second pre-determined height, H₂, by retraction of the actuating cylinders 128 of the columns 104, 106, 108, and 110. The upper arms 112, 114, 116, and 118 slide over the lower arms 120, 122, 124, and 126, respectively, on retraction of the actuating cylinders 128. The ROPS 24 is collapsed to the second pre-determined distance, D₂ by retraction of the actuators 26, of the pair of telescopic support members 132. The movable column 140 slides and accommodates inside the fixed column 138 on retraction of the actuator 26.

The proposed cab system 16 is equipped to be maintained at two different heights, H₁ and H₂. This allows the cab system 16 to collapse to a lesser height, which makes transportation convenient and efficient. The actuating cylinders 128 and the actuator 26 are arranged in such a way so as to mitigate space.

The many features and advantages of the disclosure are apparent from the detailed specification, and thus, it is intended by the appended claims to cover all such features and advantages of the disclosure that fall within the true spirit and scope thereof. Further, since numerous modifications and variations will readily occur to those skilled in the art. It is not desired to limit the disclosure to the exact construction and operation illustrated and described, and, accordingly, all suitable modifications and equivalents may be resorted to that fall within the scope of the disclosure.

What is claimed is:

1. A cab system for a machine, the machine having a frame, the cab system comprising:
a cab mounted on the frame, the cab including:
a ceiling portion;
a base portion fixedly connected to the frame;
at least one collapsible column having an upper arm connected to the ceiling portion and a lower arm connected to the base portion, the upper arm and the lower are slidably connected to each other; and
at least one actuating cylinder, the at least one actuating cylinder facilitates a slidable actuation between the ceiling portion and the base portion, and is operable to adjust a distance between the ceiling portion and the base portion between a first pre-determined height and a second pre-determined height;
a roll over protection structure (ROPS) including a canopy and a pair of telescopic support members, the pair of telescopic support members being laterally spaced apart and being substantially parallel to the upright extension of the base portion, the canopy being secured between the pair of telescopic support members to at least substantially cover the cab, each telescopic support member having a fixed column and a movable column, the movable column including a canopy end attached to the canopy, and a fixed column including a frame end connected with the frame; and
a pair of actuators, with each actuator being configured to move the movable column relative to the fixed column to adjust the canopy between a first pre-determined distance and a second pre-determined distance, along the upright extension, relative to the frame.
